(19) United States
(12) Patent Application Publication
(10) Pub. No.: US 2004/0186732 A1
(43) Pub. Date: Sep. 23, 2004

(54) Translation system

(75) Inventors: Seiji Okura, Kawasaki (JP); Akira Ushioda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/813,135

(22) Filed: Mar. 31, 2004

Related U.S. Application Data
(63) Continuation of application No. PCT/JP01/08814, filed on Oct. 5, 2001.

(51) Int. Cl. G10L 11/00

(52) U.S. Cl. 704/277

(57) ABSTRACT

This system comprises a translation unit translating an inputted original sentence by selecting each translation word one by one from a plurality of translation words corresponding to each word composing the sentence and combining the selected translation words, a voice recognition unit selecting a translation word matching inputted pronunciation from a plurality of translation words that correspond to the word and have not been selected by the translation unit, and outputting the selected translation word as a result of the voice recognition, and a correction unit correcting the sentence translated by the translation unit, using the translation word outputted from the voice recognition unit.

### CROSS-REFERENCE TO RELATED APPLICATION

This application is a continuation application of international PCT application No. PCT/JP01/08814 filed on Oct. 5, 2001.

### BACKGROUND OF THE INVENTION

1. Category of the Invention

The present invention relates to the machine translation technology of documents, in particular a technology for supporting the correction by human being of a document translated by machine.

2. Description of the Related Art

Recently the performance of machine translation has remarkably improved, and in particular it can be said that machine translation exceeds translation by human being in speed. However, when comparing machine translation with translation by human being in accuracy, translation by human being is still far better than machine translation although the difference has narrowed.

Utilizing such a feature of machine translation, a translation service of providing high-quality translation in a short time is commonly used by firstly translating documents by machine and then having a human being correct the translated document.

In the correction work of this translation service, a translator corrects translation errors and rewrites unclear portions by collating a sentence translated by machine with its original sentence one by one. In this case, the translator corrects the translated sentence by operating a mouse, a keyboard and the like. Specifically, for example, the translator selects some word to be corrected in the translated sentence displayed in a display device and inputs a new translation word to replace a translation word to be corrected from the keyboard.

Some recent machine translation systems are provided with a function to support such corrections of a translator. For example, when such a translation word to be corrected in the translated sentence is selected, a list of translation word candidates for the translation word that have not been selected in the machine translation is displayed, and by selecting an appropriate translation word from the list, the correction can be completed. Since in this case, labor needed for a translator to input the appropriate translation word can be omitted, the correction efficiency of a translated document can be improved.

However, if a lot of translation word candidates that have not been selected in the machine translation exist, a translator must search for the appropriate translation word among the translation word candidates in the above-mentioned correction support, which sometimes prevents the reduction of time needed to select them in this work.

### SUMMARY OF THE INVENTION

It is an object of the present invention to improve the efficiency of the correction by human being of a document translated by machine.

The system in one aspect of the present invention translates an original document. The system comprises a translation unit translating an original sentence by selecting each translation word one by one from a plurality of translation words matching each word composing an inputted original sentence one by one, and combining the selected translation words, a voice recognition unit selecting a word matching inputted pronunciation from a plurality of translation words that correspond to the word and have not been selected by the translation unit and outputting the selected translation word as a result of the voice recognition, and a correction unit correcting the sentence translated by the translation unit, using the translation word outputted by the voice recognition unit.

According to this configuration, if a translator (human being) instructs the system to replace some word of a sentence translated by machine with another translation word, another word of the sentence that is not instructed to be corrected can also be automatically replaced with a translation word matching the replacement of the translation word of the sentence. Therefore, labor needed for a translator to correct can be reduced.

The system in another aspect of the present invention translates an original document. The system comprises a translation unit translating an inputted original sentence, a translation word input unit inputting another translation word for another translation word of the sentence when replacing some translation word of a sentence translated by the translation unit with another translation word, and a correction unit re-translating the whole sentence using the translation word inputted by the translation word input unit when the part of speech of the new translation word inputted by the translation word input unit differs from that of the old one of the sentence to be replaced with the new translation word when correcting.

According to this configuration, if a translator instructs the system to replace some translation word of a sentence translated by machine with another translation word, another translation word of the sentence that is not instructed to be replaced can also be automatically replaced with another new translation word matching the replacement of the translation word of the sentence. Therefore, labor needed for a translator to correct can be reduced.

The system in another aspect of the present invention translates an original document. The system comprises a translation unit translating a sentence composing an original document, a correction unit correcting a sentence translated by the translation unit, and a category determination unit determining the category of the topic of the sentence, based on contents corrected by the correction unit. Thus, when translating a non-translated sentence composing the original document, a translation word that is frequently used in a category determined by the category determination unit is used with priority.

According to this configuration, the accuracy of machine translation can be improved, and as a result, labor needed for a translator to correct can be reduced.

### BRIEF DESCRIPTION OF THE DRAWINGS

The present invention will be more apparent from the following detailed description when the accompanying drawings are referenced, in which:

FIG. 1A shows the first basic configuration of the translation system implementing the present invention;

FIG. 1B shows the second basic configuration of the translation system implementing the present invention;

FIG. 1C shows the third basic configuration of the translation system implementing the present invention;

FIG. 2 shows the detailed configuration of the translation system implementing the present invention;

FIG. 3A is a flowchart showing the contents of a control process performed by a CPU;

FIG. 3B is a flowchart showing the contents of a machine translation process;

FIG. 3C is a flowchart showing the contents of a first correction supporting process;

FIG. 4 is a flowchart showing the contents of a second correction supporting process;

FIG. 5 is a flowchart showing the contents of a third correction supporting process;

FIG. 6 is a flowchart showing the contents of a fourth correction supporting process;

FIG. 7 is a flowchart showing the contents of a fifth correction supporting process; and

FIG. 8 shows examples of computer-readable storage media on which a program is recorded.

### DESCRIPTION OF THE PREFERRED EMBODIMENTS

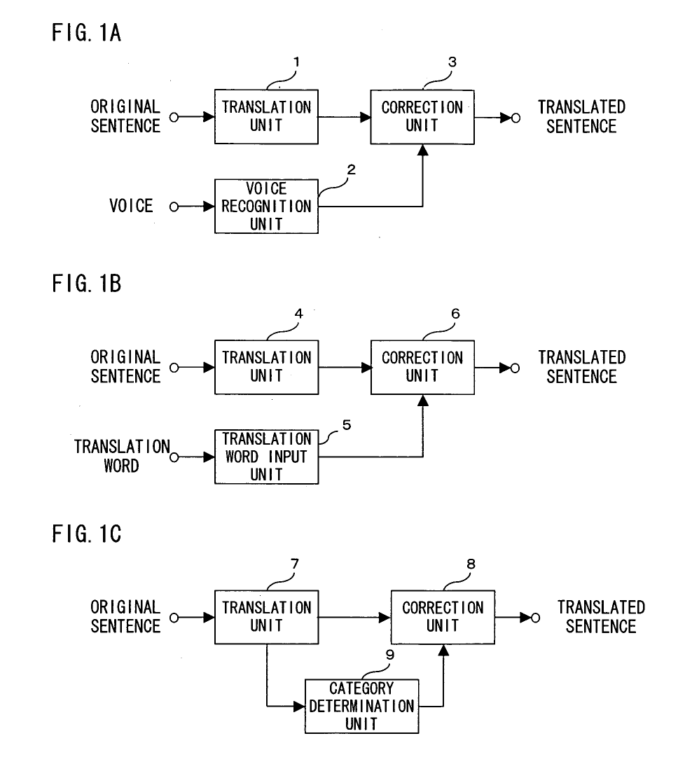

Firstly, FIGS. 1A, 1B and 1C are described. These drawings show the basic configurations of the translation system implementing the present invention.

FIG. 1A shows the first basic configuration of the translation system implementing the present invention. FIG. 1A shows a system for translating an original document.

The translation unit 1 translates an original sentence by selecting each translation word one by one from a plurality of translation words matching each word composing an inputted original sentence one by one and combining the selected translation words.

The voice recognition unit 2 selects a translation word matching inputted pronunciation from a plurality of translation words that correspond to the word and have not been selected by the translation unit, and outputs the selected translation word as a result of the voice recognition.

The correction unit 3 corrects the translated sentence by the translation unit 1, using the translation word outputted by the voice recognition unit 2.

According to this configuration, a translator can replace the inappropriate translation word of a sentence translated by the translation unit 1 with an appropriate translation word only by pronouncing the appropriate word. Furthermore, since the target of voice recognition conducted by the voice recognition unit 2 is restricted to a translation word composing an original sentence, a recognition rate higher than that targeting an unspecific word can be obtained.

The above-mentioned first basic configuration of the translation system implementing the present invention can further comprise a translation word dictionary file storage unit storing a translation word dictionary file in which each word of an original sentence and its translation words is related and registered, and an extraction unit extracting a translation word related to each word composing an original sentence inputted by the translation unit from the translation word dictionary file. In this case, the translation unit 1 selects each translation word to be used to translate a sentence one by one from a plurality of translation words extracted by the translation word extraction unit, and the voice recognition unit 2 selects a word matching inputted pronunciation from a plurality of translation words that are extracted by the translation word extraction unit and have not been selected by the translation unit 1. Thus, the same operation effect as described above can be obtained.

The above-mentioned first basic configuration of the translation system implementing the present invention can also further comprise an instruction input unit instructing the system whether to correct some translation word composing a sentence translated by the translation unit 1 or to correct the whole translated sentence. In this case, when an instruction to correct the whole sentence translated by the translation unit 1 is inputted to the instruction input unit, the voice recognition unit 2 divides information expressed by inputted pronunciation and selects a translation word matching each segment of divided information from a plurality of translation words that correspond to the word composing the translated sentence and have not been selected by the translation unit 1.

According to this configuration, when a translator determines that a sentence translated by the translation unit 1 is inappropriate as a whole, the correction of the whole sentence is collectively conducted instead of correcting it in units of translation words. In this case, since if a translator inputs a notice indicating that the translator's pronunciation is directed to a sentence, voice recognition is conducted in the assumption that a recognition target is a sentence, higher recognition accuracy can be obtained compared with a case where no such a notice is given.

In the above-mentioned first basic configuration of the translation system implementing the present invention, when a translation word that corresponds to some translation word of a sentence to be replaced and has not been selected by the translation unit 1 includes a translation word related to that outputted by the voice recognition unit 2, the correction unit 3 can also correct the sentence translated by the translation unit 1, using the translation word that has not been selected by the translation unit 1 and is outputted by the voice recognition unit 2.

According to this configuration, only if a translator instructs the system to replace some translation word of a sentence translated by the translation unit 1 with another translation word, another translation word of the sentence that is not instructed to correct can also be automatically replaced with a translation word matching the replacement. Therefore, labor needed for a translator to correct can be reduced.

In the above-mentioned first basic configuration of the translation system implementing the present invention, when the part of speech of the translation word inputted by the translation word input unit differs from that of some translation word of a sentence to be replaced when correcting the sentence, the correction unit 3 can also re-translate the whole sentence inputted by the translation unit 1, using the translation word inputted by the voice recognition unit 2.

In this configuration, if the part of speech of a translation word after correction differs from one before correction when a translator instructs the system to replace some translation word of a sentence translated by the translation unit 1 with another translation word, the system determines that there has been an error in the analysis of an original sentence conducted by the translation unit 1 and re-translates the sentence, using the translation word after correction. According to this configuration, only if a translator instructs the system to replace some translation word of a sentence translated by the translation unit 1 with another translation word if the part of speech of a translation word after correction differs from that before correction, the sentence can be automatically translated, using the translation word. Therefore, labor needed for a translator to correct can be reduced.

In this case, when the part of speech of a translation word outputted from the voice recognition unit 2 coincides with that of a translation word before correction, being a target to be replaced when correcting the sentence, the correction unit 3 can also partially replace some translation word of a sentence translated by the translation unit 1 with the translation word outputted by the voice recognition unit 2. Since a translated sentence is partially corrected thus if the part of speech of a translation word after correction coincides with that of a translation word before correction, time needed to correct can be reduced compared with a case where re-translating a whole sentence.

The above-mentioned first basic configuration of the translation system implementing the present invention can also further comprise a category determination unit determining a category to which the topic of an original sentence inputted to the translation unit 1 belongs, based on the contents corrected by the correction unit 3. In this case, the translation unit 1 uses with priority a translation word frequently used in a category determined by the category determination unit when translating a newly inputted original sentence.

In this configuration, information indicating to which category the translation word corrected by the translator, of a sentence translated by the translation unit 1 belongs, to a economical/financial category, a communication technological category, a legal category or the like, is obtained, and a sentence is translated using a translation word used in the category with priority in its translation conducted later by the translation unit 1. Thus, the accuracy of machine translation by the translation unit 1 can be improved.

In this case, the system can further comprise a translation word category information file storage unit storing a translation word category information file in which information indicating a category in which such a translation word of an original sentence is frequently used. In this case, the category determination unit determines a category in which the translation word of a translated sentence used when the correction unit 3 corrects the sentence translated by the translation unit 1, is frequently used, based on information registered in the translation word category information file. Therefore, the same operation/effect as described above can be obtained.

FIG. 1B shows the second basic configuration of the translation system implementing the present invention. FIG. 1B also shows a system for translating an original document.

A translation unit 4 translates an inputted original sentence.

A translation word input unit 5 inputs another translation word to replace a translation word used in a sentence translated by the translation unit 4.

A correction unit 6 re-translates a whole sentence translated by the translation unit 4, using another translation word inputted by the translation word input unit 5 when the part of speech of another translation word inputted to the translation word input unit 5 differs from that of some translation word of the sentence to be replaced with when correcting the sentence.

In this configuration, if the part of speech of a translation word after correction differs from that before correction when a translator instructs the system to replace some translation word of sentence translated by the translation unit 4 with another translation word, the system determines that there is an error in the analysis of an original sentence conducted by the translation unit 4, and re-translates the sentence using the translation word after correction. According to this configuration, only if a translator instructs the system to replace some translation word of a sentence translated by the translation unit 1 with another translation word when the part of speech of a translation word after correction differs from that before correction, the sentence can be automatically translated using the translation word. Therefore, labor needed for a translator to correct can be reduced.

In the second basic configuration of the translation system implementing the present invention, when the part of speech of a translation word inputted to the translation word input unit 5 coincides with that of a translation word before correction, being a target to replace some translation word of a sentence when correcting a sentence, the correction unit 6 can also partially replace the translation word of the sentence translated by the translation unit 4 with another translation word inputted to the translation word input unit 5.

According to this configuration, when the part of speech of a translation word after correction coincides with that before correction, the translated sentence is partially corrected. Therefore, time needed to correct a sentence can be reduced compared with a case where re-translating a whole sentence.

FIG. 1C shows the third basic configuration of the translation system implementing the present invention. FIG. 1C shows a system for translating a document.

A translation unit 7 translates an original sentence composing a document.

A correction unit 8 corrects the sentence translated by the translation unit 7.

A category determination unit 9 determines a category to which the topic of an original sentence belongs, based on the contents corrected by the correction unit 8.

In this configuration, when translating a non-translated original sentence composing a document, the translation unit 7 uses with priority a translation word frequently used in the category determined by the category determination unit 9.

In this configuration, information indicating to which category the translation word of a sentence translated by the translation unit 7 that is corrected by a translator, belongs, to an economical/financial category, a communication technological category, a legal category or the like, is obtained and then a translation word used in the category is used with priority when the translation unit 7 translates the sentence. Thus, the accuracy of machine translation by the translation unit 7 can be improved, and as a result, labor needed for a translator to correct can be reduced.

The above-mentioned third basic configuration of the translation system implementing the present invention can also further comprise a translation word category information file storage unit storing a translation word category information file in which information indicating a category in which such a translation word frequently used in an original sentence is registered. In this case, the category determination unit 9 determines a category in which the translation word of a translated sentence that is corrected by the correction unit 8 is frequently used, based on the information registered in the translation word category information file. Thus, the same operation/effect as described above can also be obtained.

Alternatively, it can also further comprise a translation word dictionary file storage unit storing a translation word dictionary file in which each word used in an original sentence and its translation word are related and registered and information indicating a category in which such translation word is frequently used. In this case, the translation unit 7 translates a non-translated original sentence composing a document, using a translation word that corresponds to the word of an inputted original sentence, of a plurality of translation words registered in the translation word dictionary file and using information indicating that such a translation word is frequently used in the category determined by the category determination unit 9 registered in the translation word dictionary file. Thus, the same operation/effect as described above can also be obtained.

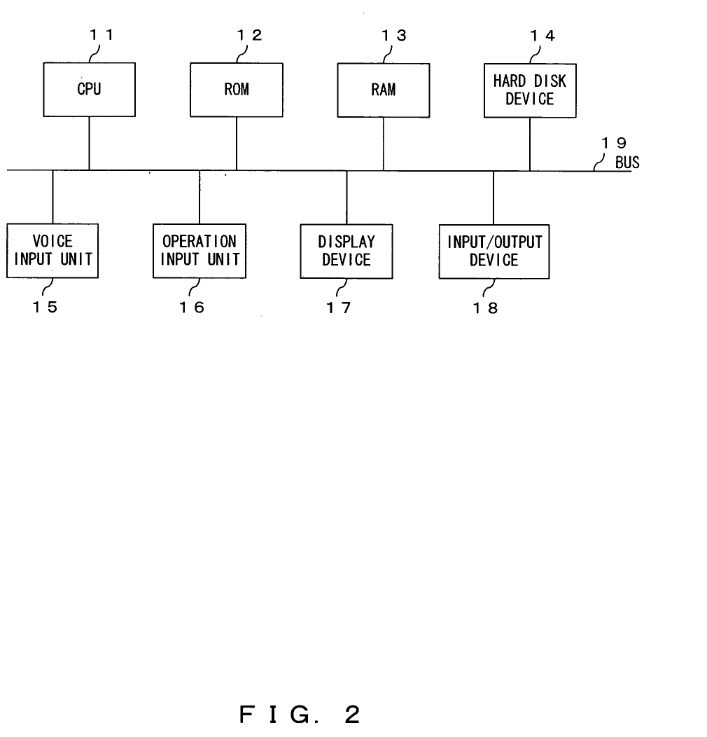

Next, FIG. 2 is described. FIG. 2 shows the detailed configuration of the translation system implementing the present invention. The system comprises a CPU (central processing unit) 11, ROM (read-only memory) 12, RAM (random-access memory) 13, a hard disk device 14, a voice input unit 15, an operation input unit 16, a display device 17 and an input/output device 18, which are all connected to each other through a bus 19 and between which data is transmitted/received.

The CPU 11 takes charge of the operation control of the entire translation system.

The ROM 12 stores in advance a control program executed by the CPU 11. The CPU 11 controls the operation of the entire system by executing this control program.

The RAM 13 temporarily stores a variety of data, and is used as work memory, if necessary, when the CPU 11 executes the control program stored in the ROM 12.

The hard disk device 14 stores in advance a translation word dictionary file in which each word of an original sentence before translation and its translation word in the translated sentence are related and stored. This translation word dictionary file also stores information indicating the part of speech of each translation word and information indicating the strength of the relationship between them. Furthermore, the file stores information indicating a category in which each translation word is used when translating a sentence used in each category, such as an economical/financial category, a communication technological category, a legal category or the like when translating a sentence used in each category.

Alternatively, instead of storing the above-mentioned control program in the ROM 12, the program can be stored in advance in the hard disk device. In this case, when this translation system is activated, the CPU 11 can control the operation of the entire translation system by reading this control program from the hard disk device 14, temporarily storing it in the RAM 13, and then reading/executing it.

The voice input unit 15 obtains pronunciation inputted by a translator that translates sentences using this translation system, and converts the pronunciation into audio data.

The operation input unit 16 comprises an input device, such as a keyboard, a mouse and the like, which a translator operates when translating sentences using this translation system. This unit 16 obtains the operation situation of these input devices.

The display device 17 displays as instructed by the CPU 11. For the display device 17, a CRT (cathode ray tube), an LCD (liquid crystal display) or the like is used.

The input device 18 receives information inputted from the outside, such as document data described in an original sentence to be translated, and transmits it to the CPU 11 or outputs it from the CPU 11, such as a translated sentence, as a result. For the input/output device 18, a portable storage medium reading/writing device, such as a FD (flexible disk), a CD-ROM (compact disk ROM) a DVD-ROM (digital versatile disk ROM), an MO (magneto-optics) disk or the like, is used. An interface device exchanging input/output information between the translation system device 18 and another device through a communication network can also be used as the input/output device 18. Furthermore, a printer device printing the contents of an output from the CPU 11 on paper can also be used as the input/output device 18.

The configuration of the translation system shown in FIG. 2 is that of a standard computer system. Therefore, such a computer can also implement the present invention.

Next, the control process of the CPU 11 in the translation system shown in FIG. 2 is described. Each of the following processes is realized by the CPU 11 executing a program for controlling this translation system.

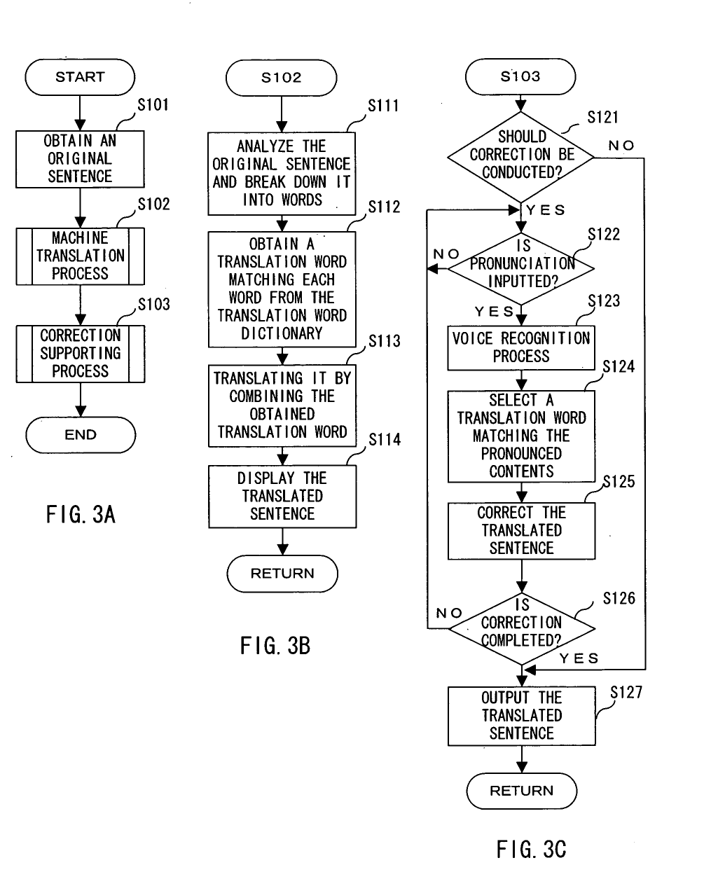

Firstly, FIGS. 3A, 3B and 3C are described. FIGS. 3A, 3B and 3C are flowcharts showing the contents of the control process of the CPU 11. Translation is conducted by the CPU 11 performing the processes shown in 3A, 3B and 3C.

Firstly, the flowchart shown in FIG. 3A, being a main flow, is described.

Firstly, in step S101, an original sentence, being a translation target, is obtained. In this process, data representing an original sentence that is inputted to the input/output device 18 is temporarily stored in the RAM 13.

In step S102, machine translation is conducted. FIG. 3B is a detailed flowchart showing the contents of this machine translation process, which is described later.

In step S103, correction support is conducted. FIG. 3C is a detailed flowchart showing the contents of this correction supporting process, which is also described later. When the process in step S103 is completed, this main flow terminates.

Next, the flowchart showing the contents of the machine translation process in step S102 is described.

Firstly, in step S111, an original sentence is analyzed and is broken down into words. In this process, the original sentence represented by the data stored in the RAM 13 in step S101 is broken down into words. This analysis of an original sentence is conducted using a publicly known analyzing method, such as a morphological analysis or the like.

In step S112, a translation word matching each word is obtained from a translation word dictionary. In this process, a translation word dictionary file stored in the hard disk device 14 is referenced, and one or more translation words matching each word that is obtained by analyzing the original sentence in step S111, are obtained from the translation word dictionary file.

In step S113, a sentence is translated by combining the translation words. In this process, firstly, each translation word to be used is selected from the translation words obtained in step S112. For this selection method of a translation word, a method publicly known in the category of a machine translation technology can be used. For example, the statistical data of previous translation is registered in the translation word dictionary file in advance, and a translation word most frequently selected in translation is selected. Then, by combining the translation words selected in this process, a translated sentence is generated. For this translation word combining process, a method publicly known in the category of a machine translation technology can also be used.

In step S114, the translated sentence is displayed. In this process, an instruction to display the sentence translated in step S112 is given to the display device 17, and the display device 17 displays the translated sentence according to this instruction.

When the process in step S114 is completed, the process in step S102 terminates, and the process returns to the flowchart shown in FIG. 3A.

Next, a flowchart showing the contents of the correction supporting process in step S103 shown in FIG. 3C is described. According to this method for supporting the correction of a sentence translated in this process, a translator can replace the inappropriate translation word of a translated sentence with an appropriate one only by pronouncing the appropriate word.

Firstly, in step S121, it is determined whether correction should be conducted. In this process, a translator using this translation system sees a sentence translated by machine that is displayed on the display device 17, and determines whether this translated sentence is correct. Then, the translator performs an operation indicating whether correction should be conducted on the operation input unit 16, based on this determination. The CPU 11 determines whether to conduct correction, based on the contents of this operation on the operation input unit 16.

If the determination in step S121 is yes, that is, correction should be conducted, the process proceeds to step S122. If the determination in step S121 is no, that is, correction need not be conducted, the process proceeds to step S127.

In step S122, it is determined whether pronunciation is inputted. In this process, it is determined whether the voice input unit 15 has obtained the translator's pronunciation representing a translation word. Until this determination becomes yes, that is, it is determined that the pronunciation is inputted, the process in step S122 is repeated.

In step S123, the pronunciation is recognized, and data representing the translator's pronunciation outputted from the voice input unit 15 is analyzed. Then, the pronounced contents of the translator are specified.

In step S124, a translation word matching the pronounced contents of the translator is selected from all translation words obtained from the translation word dictionary file in the above-mentioned machine translation process. In this process, the contents that are pronounced by the translator and are specified in step S123 are compared with the pronounced contents of each of all translation words that are obtained from the translation word dictionary file stored in the hard disk device 14 in step S112 shown in FIG. 3B and that are related to each word composing an original sentence, and a translation word most closely related with the contents that are pronounced by the translator and are specified in step S123 is selected. Since the recognition target of the voice recognition conducted in the preferred embodiment is limited to a translation word related to each word composing the original sentence thus, a recognition rate higher than that of the voice recognition that targets an unspecific word can be obtained.

In step S125, the translated sentence is corrected. In this process, firstly, the word related to the translation word selected in step S124 is obtained from the translation word dictionary file stored in the hard disk device 14. Then, the translation of the word is deleted from the translated sentence displayed on the display device 17, and a new sentence is translated by combining the translation word newly selected in step S124 and the remaining translation words of the translated sentence. Thus, the translator can correct the translated sentence without an instructing operation to specify a translation word needed to correct in a sentence translated by machine that is displayed on the display device 17. The translated sentence after correction is displayed on the display device 17.

In step S126, it is determined whether correction is completed. In this process, a translator using this translation system sees the translated sentence after correction that is displayed on the display device 17 and determines whether this translated sentence is correct. Then, the translator performs an operation indicating whether correction should be further continued on the operation input unit 16, based on this determination. The CPU 11 determines whether correction is completed, based on the contents of this operation on the operation input unit 16. Alternatively, if the translator vocally expresses his intention of whether to further continue his correction and the CPU 11 vocally recognizes the contents of the pronunciation, the CPU 11 can recognize the intention of the translator.

If the determination in step S126 is yes, that is, correction should be terminated, the process proceeds to step S127. If the determination in step S126 is no, that is, correction should be continued, the process returns to step S122 and the above-mentioned process is repeated.

In step S127, the translated sentence is outputted. In this process, data representing the translated sentence currently displayed on the display device 17 is transmitted to the input/output device 18. Then, the input/output device 18 records the data in a variety of storage media, and prints the translated sentence on paper or transmits it to another device on the communication network.

When the process in step S127 is completed, the process in step S103 terminates, and the process returns to the flowchart shown in FIG. 3A.

If the CPU 11 performs the above-mentioned processes, translation can be conducted using this translation system. An actual translation process using this translation system is described below using an example of translation from English to Japanese.

It is assumed that an original sentence, being a translation target, is “I saved money.”

Firstly, the machine translation process in step S102 is performed. In step S112 it is assumed that the following translation words are obtained from the translation word dictionary file stored in the hard disk device 14.

“I” . . . ┌ [symbol] ┘ (reads ‘watashi’)

“save” . . . ┌ [symbol] ┘ (reads ‘sukuu’)

“save” . . . ┌ [symbol] ┘ (reads ‘setuyaku suru’)

“save” . . . ┌ [symbol] ┘ (reads ‘hozon suru’)

“money” . . . ┌ [symbol] ┘ (reads ‘kane’)

Here, it is also assumed that the original sentence “I saved money” is translated into a Japanese sentence, ┌ [symbol] ┘ by the process in step S113, and ┌ [symbol] ┘ is displayed on the display device 17. If a translator sees this translated sentence, determines that correction is needed and gives an instruction to correct it operating the operation input unit 16, the determination in step S121 becomes yes, and a correction supporting process starts.

Then, when the translator pronounces ‘setsuyaku shita’, the voice input unit 15 obtains this pronunciation, and the voice recognition process in step S123 is performed. Then, in step S124, of the translation words obtained in step S112, ┌ [symbol] ┘, ┌ [symbol] ┘, ┌ [symbol] ┘, ┌ [symbol] ┘ and ┌ [symbol] ┘, ┌ [symbol] ┘, the translation word most closely related to the translator's pronunciation is selected.

Then, in step S125, the old translation word ┌ [symbol] ┘ of an original word “save” is deleted from the translation candidates of a translated sentence, and a translated sentence, ┌ [symbol] ┘ is generated using the translation words, ┌ [symbol] ┘, ┌ [symbol] ┘, and ┌ [symbol] ┘. Thus, correction is completed, and an appropriate translation is outputted.

Next, another example of the control process of the CPU 11 in the translation system shown in FIG. 2 is described.

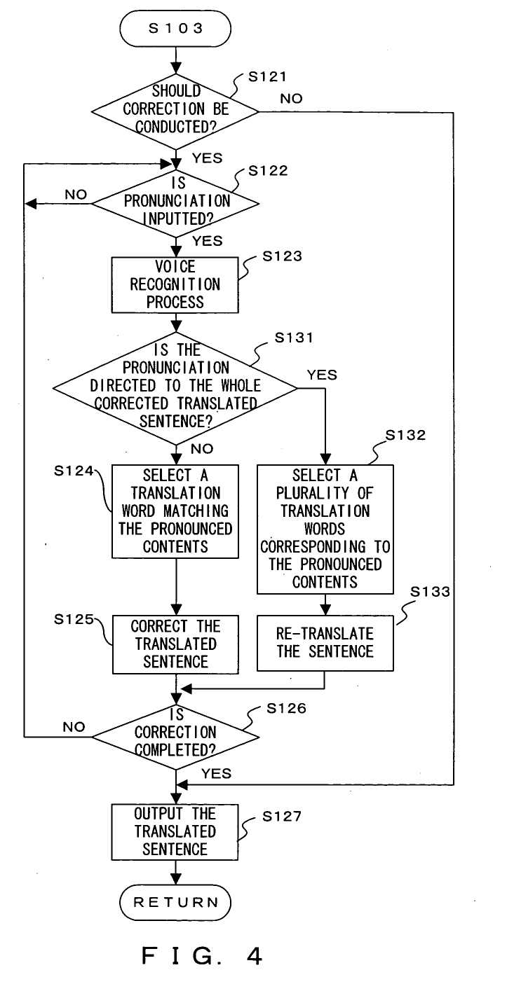

FIG. 4 is a flowchart showing the contents of the second correction supporting process in step S103 shown in FIG. 3A. In this process, a whole sentence is collectively corrected, instead of correcting a sentence in units of translation words like the above-mentioned correction supporting process when a translator determines that a sentence translated by machine is inappropriate as a whole. In order to distinguish a correction supporting process to be described below from that shown in FIG. 3C, the above-mentioned correction supporting process shown in FIG. 3C is called as the first correction supporting process.

In FIG. 4, the same reference numerals are attached to the same process steps as those of the first correction supporting process shown in FIG. 3C, and their descriptions are omitted here.

As known when comparing FIG. 4 with FIG. 3C, in the flowchart shown in FIG. 4, a determination process in step S131 is inserted between steps S123 and S124 of the flowchart shown in FIG. 3C, and the process in S132 or S133 is performed based on the result of this determination, instead of the process in S124 or S125, respectively. These processes are described below.

In step S131 following the voice recognition process in step S123, it is determined whether the translator's pronunciation is directed to a whole translated sentence to be corrected. In this process, the translator performs an operation indicating whether the translator's pronunciation is directed to a whole translated sentence to be corrected on the operation input unit 16. Then, the CPU 11 determines the translator's pronunciation is directed to a whole translated sentence to be corrected, based on the contents of the operation performed on the operation input unit 16.

If the determination in step S131 is yes, that is, the translator's pronunciation is directed to a whole translated sentence to be corrected, the process proceeds to S132. If the determination in step S131 is no, that is, the translator's pronunciation is directed to a translation word to be corrected, the process proceeds to S124, and after that the same process as shown in FIG. 3C is performed.

In step S132, a plurality of translation words matching the translator's pronounced contents are selected. In this process, the pronunciation of each of all translation words that are obtained from the translation word dictionary file stored in the hard disk device 14 in step S112 shown in FIG. 3B and are related to the word composing an original sentence is compared with a part of the translator's pronounced contents, and a translation word which is most closely correlated to the part of the translator's pronounced contents and whose correlation with the part of the translator's pronounced contents exceeds a predetermined value, is selected. In this case, no translation word which is most closely correlated to the part of the translator's pronounced contents and whose correlation with the part of the translator's pronounced contents exceeds a predetermined value exists, the comparison is conducted again by shifting the range including the part of the pronounced contents to be compared. If a translation word whose correlation with the part of the translator's pronounced contents exceeds a predetermined value exists, the translation word is selected. If such a translation word is selected, the same comparison and selection is applied to a part of the remaining part of the translator's pronounced contents to be compared. By repeating such a comparison and selection, all the translation words of the corrected translated sentence pronounced by the translator are selected.

In step S133, a translated sentence is generated. In this process, a new sentence is translated by combining the translation words selected in step S132. The translated sentence after correction is displayed on the display device 17.

When the process in step S133 is completed, the process proceeds to S126, and after that the same process as shown in FIG. 3C is performed.

As described above, by notifying this translation system of the fact that the translator's pronunciation is directed at a sentence, a translator can perform the voice recognition process of a sentence. Therefore, higher recognition accuracy can be obtained compared with a case where no such notification is conducted.

Actual translation conducted by the CPU 11 in the correction supporting process shown in FIG. 4 is described below using an example of translation from English to Japanese.

It is assumed that an original sentence to be translated is “Time flies like an arrow” and that a result translated by machine in step S102 is a proverb ┌ [symbol] ┘. However, in this example, it is also assumed that ┌ [symbol] ┘ is more appropriate from the viewpoint of the context of an original document. In this case, it is also assumed that the following words are registered in the translation word dictionary file stored in the hard disk device 14:

“time” . . . ┌ [symbol] ┘ (reads ‘toki’)

“fly” . . . ┌ [symbol] ┘ (reads ‘hae’)

“like” . . . ┌ [symbol] ┘ (reads ‘sukidearu’)

“arrow” . . . ┌ [symbol] ┘ (reads ‘ya’)

“Time flies like an arrow” . . . ┌ [symbol] ┘ (reads ‘kouinn ya no gotoshi’)

In this case, a translator pronounces ‘tokihae wa ya ga sukidearu’ and further notifies the system of the fact that this pronunciation is directed to the whole corrected translated sentence operating the operation input unit 16. Then, the CPU 11 determines that the determination in step S131 is yes. In step S132, the CPU 11 selects translation words, ┌ [symbol] ┘, ┌ [symbol] ┘, ┌ [symbol] ┘ and ┌ [symbol] ┘, based on the translator's pronounced contents, and in step S133, a translated sentence, ┌ [symbol] ┘ is generated.

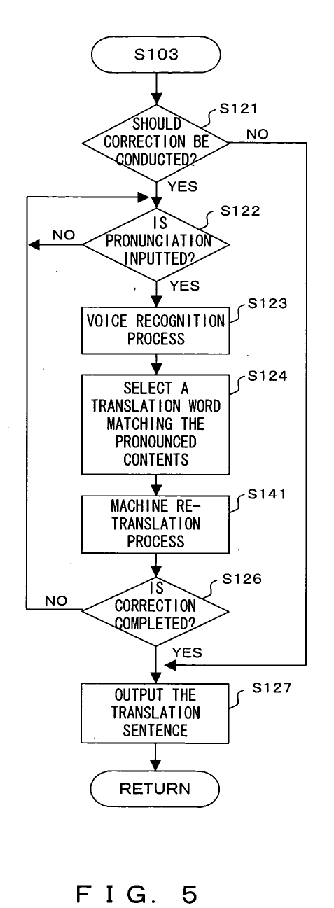

Next, FIG. 5 is described. FIG. 5 is a flowchart showing the third correction supporting process in step S103 shown in FIG. 3A. In this process, if an instruction to replace some translation word of a sentence translated by machine with another one is given, a new sentence is generated by machine using the different translation word.

In FIG. 5, the same reference numerals are attached to the same process steps as those of the first correction supporting process shown in FIG. 3C, and their descriptions are omitted here.

As known when comparing FIG. 5 with FIG. 3C, in the flowchart shown in FIG. 5, the process in step S125 of the flowchart shown in FIG. 3C is replaced with a process in step S141. This process is descried below.

After a translation word matching the translator's pronounced contents is selected from all translation words obtained from the translation word dictionary file in the above-mentioned machine translation process of step S124, in step S141, a new translated sentence is generated by machine.

In the process of step S141, firstly, translation words to be used are selected from translation words obtained in step S112 as in step S113 shown in FIG. 3B. In this case, if information indicating that some translation word is closely related to another one selected in step S124 is stored in the translation word dictionary file, the translation word is selected with priority. Then, a new translated sentence is generated by combining the translation words selected in this process.

When the process in step S141 is completed, the process proceeds to step S126. After that, the same process as shown in FIG. 3C is performed.

By the above-mentioned process, a new translated sentence in which the translation word other than the corrected one are also replaced with ones matching the corrected translation word, is generated by machine only if a translator instructs the system to replace some translation word of a sentence translated by machine with another translation word. Therefore, labor needed for a translator to correct can be reduced.

Actual translation by the correction supporting process of the CPU 11 shown in FIG. 5 is described below using an example of translation from English to Japanese.

It is assumed that an original sentence, being a translation target, is “The bank cut interest rates” and a sentence translated by machine in step S102 is ┌ [symbol] ┘.

In this case, it is assumed that the following translation words are registered in advance in the translation word dictionary file stored in the hard disk device 14, and that information indicating that translation words, ┌ [symbol] ┘ and ┌ [symbol] ┘ are closely related, that is, they are frequently used together, is also registered.

“bank” . . . ┌ [symbol] ┘ (reads ‘ginkou’)

“cut” . . . ┌ [symbol] ┘ (reads ‘kiru’)

“cut” . . . ┌ [symbol] ┘ (reads ‘kirisageru’)

“interest” . . . ┌ [symbol] ┘ (reads ‘kyoumi’)

“rate” . . . ┌ [symbol] ┘ (reads ‘ritsu’)

“interest rate” . . . ┌ [symbol] ┘ (reads ‘kinri’)

In this case, when a translator pronounces ‘kinri’, the voice input unit 15 obtains this pronunciation and voice recognition is conducted in step S123. Then, in step S124, a translation word most closely related to the translator's pronunciation, ┌ [symbol] ┘ is selected from the translation words obtained in step S112, ┌ [symbol] ┘, ┌ [symbol] ┘, ┌ [symbol] ┘, ┌ [symbol] ┘, ┌ [symbol] ┘ and ┌ [symbol] ┘.

Then, in step S125, the old translation words, ┌ [symbol] ┘ and ┌ [symbol] ┘ for the word of the original sentence, “interest rate” that have been related to ┌ [symbol] ┘ are deleted from translation candidates of the sentence. Then, in step S141, a translation word ┌ [symbol] ┘ is selected with priority in place of ┌ [symbol] ┘ as the translation word of a word “cut”, since information indicating that the translation word ┌ [symbol] ┘ is closely related to the translation word ┌ [symbol] ┘, is registered in the translation word dictionary file. Then, a new translated sentence, ┌ [symbol] ┘ is generated using the translation words selected thus, ┌ [symbol] ┘ and ┌ [symbol] ┘, and the translation word ┌ [symbol] ┘. Thus, correction is completed, and an appropriate translated sentence is outputted.

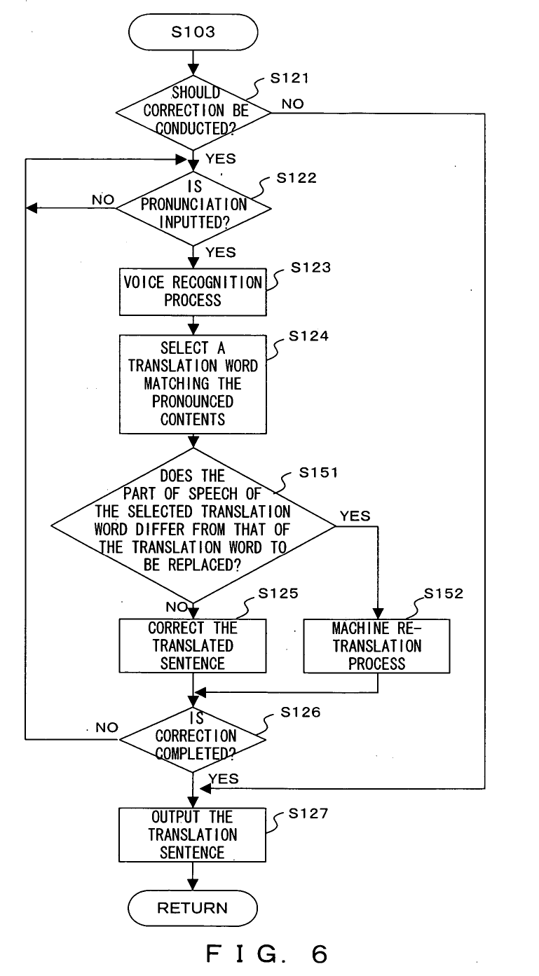

Next, FIG. 6 is described below. FIG. 6 is a flowchart showing the contents of the fourth correction supporting process in step S103 shown in FIG. 3A. In this process, if the part of speech of a translation word after correction differs from one before correction when an instruction to replace some translation word of a sentence translated by machine with another translation word is given, it is regarded that there is an error in the analysis of an original sentence conducted in machine translation, and a new translated sentence is generated by machine using translation words after correction.

In FIG. 6, the same reference numerals are attached to the same process steps as those of the first correction supporting process shown in FIG. 3C, and their descriptions are omitted here.

As known when comparing FIG. 6 with FIG. 3C, in the flowchart shown in FIG. 6, a determination process in step S151 is inserted between the steps S124 and S125 of the flowchart shown in FIG. 3C, and based on this determination, a process in step S152 is performed instead of the process in step S125. This process is described below.

After a translation word matching the translator's pronounced contents is selected from all translation words obtained from the translation word dictionary file in the above-mentioned machine translation process of step S124, in step S151, it is determined whether the part of speech of the selected translation word differs from that of the translation word to be corrected. In this process, the part of speech of the translation word selected in step S124 is obtained by referring to the translation word dictionary file. Furthermore, the part of speech of the old translation of the word, in a previously translated sentence is also obtained by referring to the translation word dictionary file. Then, it is determined whether both parts of speech are different.

If the determination of step S151 is yes, that is, the part of speech of the translation word selected in step S124 differs from that of the translation word to be corrected, the process proceeds to step S152. If the determination in step S151 is no, that is, the part of speech of the translation word selected in step S124 coincides with that of the translation word to be corrected, the process proceeds to step S125. After that, the same process as shown in FIG. 3C is performed.

In step S152, a new translated sentence is generated by machine.

In step S152, as in step S113 of FIG. 3B, firstly, translation words to be used in a translated sentence are selected from the translation words selected in step S112. In this case, the translation word selected in step S124 is selected with priority. Then, a new translated sentence is generated by combining the translation words selected in this process.

When the process in step S152 is completed, the process proceeds to step S126. After that, the same process as shown in FIG. 3C is performed.

By the above-mentioned process, even if the part of speech of a translation word after correction differs from that of a translation word before correction, when a translator instructs the system to replace some translation word of a sentence translated by machine with another translation word, a new sentence can be translated by machine using the translation word. Therefore, labor needed for a translator to correct can be reduced.

Actual translation by the correction supporting process of the CPU 11 shown in FIG. 6 is described below using an example of translation from English to Japanese.

In this example, it is assumed that an original sentence to be translated is “Time flies like an arrow” as in the second correction supporting process, and that although a sentence translated by machine in step S102 is ┌ [symbol] ┘, actually ┌ [symbol] ┘ is more appropriate from the viewpoint of the context of an original document. In this case, the English words and their Japanese translations that are registered in the translation word dictionary file stored in the hard disk device 14 are the same as those in the second correction supporting process. It is also assumed that the translation word dictionary file stores information indicating that the part of speech of the translation word ┌ [symbol] ┘ is an adjective verb and information indicating that the part of speech of ┌ [symbol] ┘ in the translation word ┌ [symbol] ┘ that corresponds to the word “like” is an adjective.

In this case, a translator pronounces ‘sukidearu’, the voice input unit 15 obtains this pronunciation, and voice recognition is performed in step S123. Then, in step S124, the translation word most closely related to the translator's pronunciation, ┌ [symbol] ┘ is selected from the translation words previously obtained in step S112, ┌ [symbol] ┘, ┌ [symbol] ┘, ┌ [symbol] ┘, ┌ [symbol] ┘ and ┌ [symbol] ┘.

Then, in step S151, both the part of speech of the translation word ┌ [symbol] ┘ and the part of speech of ┌ [symbol] ┘ in the translation word ┌ [symbol] ┘ that corresponds to the word “like” can be obtained by referring to the translation word dictionary file, and it is determined whether both parts of speech are different. In this example, since they are a verb and an adjective, that is, they are different, the determination in step S151 is yes, and the process proceeds to step S152. Thus, ┌ [symbol] ┘ is selected in place of ┌ [symbol] ┘, and a translated sentence ┌ [symbol] ┘ is generated also using translation words, ┌ [symbol] ┘, ┌ [symbol] ┘ and ┌ [symbol] ┘. Thus, correction is completed and an appropriate translated sentence is outputted.

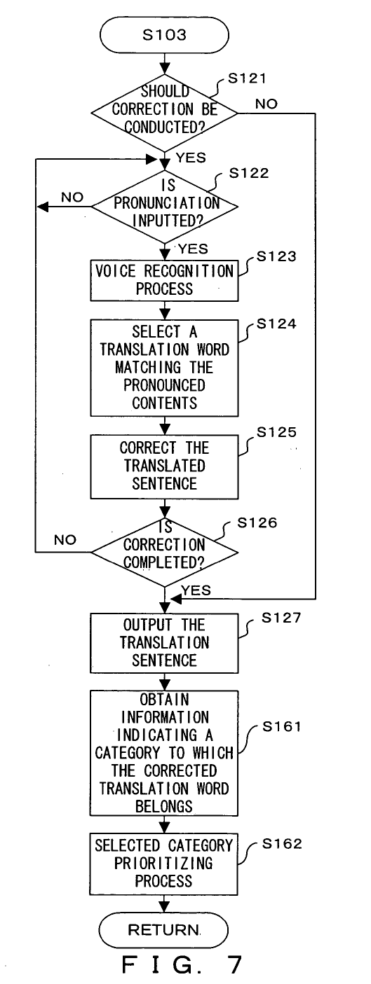

Next, FIG. 7 is described below. FIG. 7 is a flowchart showing the contents of the fifth correction supporting process in step S103 shown in FIG. 3A. In this process, the accuracy of machine translation is improved by obtaining information indicating in which category the translation word of a translated sentence, corrected by a translator is used in an economical/financial category, a communication technological category or a legal category, and by translating a sentence using with priority a translation word frequently used in such a category in machine translation conducted later.

In FIG. 7, the same reference numerals are attached to the same process steps as those of the first correction supporting process shown in FIG. 3C, and their descriptions are omitted here.

As known when comparing FIG. 7 with FIG. 3C, in the flowchart shown in FIG. 7, the processes in step S161 and 162 are performed following the process of step S127 in the flowchart shown in FIG. 3C. These processes are described below.

In step S161 following the process in step S127 of outputting a translated sentence, information indicating a category to which the corrected translation word belongs is obtained. In this process, a category to which the translation word previously selected in step S124 belongs is obtained from the translation word dictionary file stored in the hard disk device 14.

In step S162, a translation word that belongs to the category obtained in step S161 is with priority selected. In this process, firstly, information indicating the category obtained in step S161 is stored in the prescribed area of the RAM 13, and in succession, the machine translation process shown in FIG. 3B is performed. In this machine translation process, when selecting a translation word in the sentence translation process of step S113, this information stored in the RAM 13 is referenced and a translation word used in the category obtained in step S161 is selected with priority.

When this process in step S162 is completed, the process in step S103 terminates, and the process returns to the flowchart shown in FIG. 3A.

By the above-mentioned process, a sentence is translated using with priority a translation word frequently used in such a category, such as an economical/financial category, a communication technological category, a legal category or the like when a translator corrects the translation word of a translated sentence in machine translation later, and the accuracy of machine translation is improved. Therefore, labor needed for a translator to correct can be reduced.

Actual translation by the correction supporting process of the CPU 11 shown in FIG. 7 is described below using an example of translation from English to Japanese.

In this example, it is assumed that an original sentence to be translated is “The bank cut interest rates”, and that its translated sentence is corrected according to a translator's instruction to use a translation word ┌ [symbol] ┘ and a new translated sentence ┌ [symbol] ┘ is obtained. In this case, it is also assumed that information indicating that the translation word ┌ [symbol] ┘ is used in an economical/financial category is registered in the translation word dictionary file stored in the hard disk device 14.

“Japan” . . . ┌ [symbol] ┘ (reads ‘nihon’)

“relax” . . . ┌ [symbol] ┘ (reads ‘rirakkusu suru’)

“relax” . . . ┌ [symbol] ┘ (reads ‘kanwa suru’)

“regulation” . . . ┌ [symbol] ┘ (reads ‘kisoku’

“regulation” . . . ┌ [symbol] ┘ (reads ‘kisei’)

It is also assumed that a subsequent original sentence to be translated is “Japan relaxed regulations.” In this case, it is also assumed the following translation words are in advance registered in the translation word dictionary file stored in the hard disk device 14 and that information indicating that of these translation words, translation words ┌ [symbol] ┘ and ┌ [symbol] ┘ are frequently used together is registered. Furthermore, it is assumed that information indicating that the translation word for “interest rate”, ┌ [symbol] ┘ is frequently used together with them is also registered.

In this case, in step S161, a category to which a corrected translation word ┌ [symbol] ┘ belongs is checked, and information indicating that this translation word belongs to an economical/financial category is obtained from the translation word dictionary file. Then, in step S162, the obtained information is stored in the prescribed area of the RAM 13. Then, when translation words are selected in the sentence translation process in step S113 of the machine translation of “Japan relaxed regulations” later, the translation words that are frequently used in the economical/financial category, ┌ [symbol] ┘ and ┌ [symbol] ┘, have priority over ┌ [symbol] ┘ and ┌ [symbol] ┘, and are selected, based on the stored contents of the RAM 13. Then, a new translated sentence, ┌ [symbol] ┘, which is more appropriate than ┌ [symbol] ┘, is generated using the translation words selected thus, ┌ [symbol] ┘ and ┌ [symbol] ┘, and a translation word ┌ [symbol] ┘. Thus, correction is completed, and appropriate translation is outputted.

By generating a control program for enabling a computer to execute the same process as conducted by the above-mentioned CPU 11 of the translation system in the preferred embodiment of the present invention and by enabling the computer to read/execute the control program, the present invention can be implemented by a general-purpose computer.

Alternatively, by storing such a control program in a computer-readable storage medium and enabling a computer to read/execute the program, the present invention can be implemented by the computer.

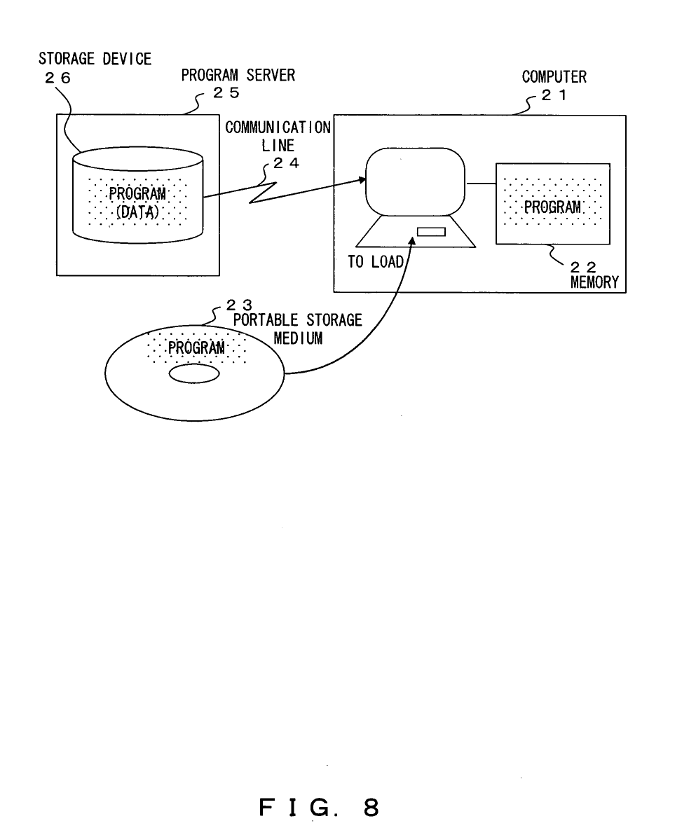

Examples of computer-readable storage media on which is recorded such a control program are shown in FIG. 8.

As shown in FIG. 8, for the storage medium, a memory 22, such as a ROM (read-only memory) built in a computer 21 or externally attached to it, or a portable storage medium memory 23, such as a FD (flexible disk), an MO (Magneto-optical disk), a CD-ROM (compact-disk read-only memory), a DVD-ROM (digital-versatile-disk read-only memory) or the like, can be used. The storage medium can also be a storage device 26 of a computer that is connected to the computer 21 through a communication network 24 and functions as a program server 25. In this case, the control program is implemented by transmitting a transmission signal obtained by modulating a carrier wave with data signals representing the control program from a program server 25 through the communication network, being a transmission medium, and by enabling the computer 21 to demodulate the transmission signal and to reproduce the control program.

Although several preferred embodiments of the present invention have been so far described, the present invention is not limited to the above-mentioned preferred embodiments, and a variety of improvements and modifications are also possible.

As described above, according one aspect of the present invention, to translate an original sentence, the processes of translating an inputted original sentence by selecting each translation word one by one from a plurality of translation words corresponding to each word composing the original sentence and combining the selected translation words as a result of machine translation, selecting a translation word matching inputted pronunciation from a plurality of translation words that correspond to the word but have not been selected by the translation unit and outputting the selected translation word as a result of the voice recognition, and correcting the sentence which is the result of the machine translation, using the translation word which is the result of the voice recognition are performed.

With above configuration of the present invention, a sentence in which other translation words not instructed to correct are also replaced with other appropriate translation words can be automatically generated only if a translator instructs the system to replace some translated word of the sentence translated by machine with another one. Therefore, labor needed for a translator to correct can be reduced.

Alternatively, according to another aspect of the present invention, to translate an original sentence, the processes of translating an inputted original sentence, determining whether apart of speech of another translation word to be inputted to replace a translation word of a translated sentence differs from a part of speech of the translation word to be replaced with another translation, and re-translating the whole original sentence, using the inputted translation word if the part of speech of another translation word to replace differs from the part of speech of a translation word before correction to be replaced are performed.

With above configuration of the present invention, the whole sentence is re-translated using the inputted translation word and a new translated sentence can be automatically generated using the new translation word only if a translator instructs the system to replace some translated word of the sentence translated by machine with another one when the new translation word after correction differs from that of the old one before correction. Therefore, labor needed for a translator to correct can be reduced.

Alternatively, according to another aspect of the present invention, to translate an original sentence, the processes of determining a category to which a topic of the original sentence belongs, based on corrected contents of an original sentence composing a previously translated document, and translating the original sentence using with priority a translation word frequently used in the category when translating a non-translated sentence composing the document by machine are performed.

With above configuration of the present invention, the accuracy of the correction by human being, of a sentence translated by machine can be improved, and as a result, labor needed for a translator to correct can be reduced.

The present invention is suitable for the use in a system for supporting document translation.

What is claimed is:

1. A system for translating an original sentence, comprising:
a translation unit translating an inputted original sentence by selecting each translation word one by one from a plurality of translation words corresponding to each word composing the original sentence and combining the selected translation words;
a voice recognition unit selecting a translation word matching inputted pronunciation from a plurality of translation words that correspond to the word but have not been selected by the translation unit, and outputting the selected translation word as a result of the voice recognition; and
a correction unit correcting the sentence translated by the translation unit using the translation words outputted from the voice recognition unit.

2. The system according to claim 1, further comprising:
a translation word dictionary file storage unit storing a translation word dictionary file in which both a word used in the original sentence and a translation word for the word are related and registered; and
an extraction unit extracting a translation word related to each word composing the original sentence inputted to the translation unit,
wherein
said translation unit selects a translation word to be used in a translated sentence from a plurality of the translation words selected by the extraction unit, and
said voice recognition unit selects a translation word matching to inputted pronunciation from a plurality of the translation words extracted by the extraction unit and have not been selected by said translation unit.

3. The system according to claim 1, further comprising
an instruction input unit instructing said system to replace some translation word composing the sentence translated by said translation unit with another translation word or to correct the whole translated sentence,
wherein
when an instruction to correct the whole sentence translated by said translation unit is inputted to the instruction input unit, said voice recognition unit divides information indicating the inputted pronunciation and selecting a translation word matching the divided information from the plurality of translation words that correspond to the word but have not been selected by said translation unit.

4. The system according to claim 1, wherein
when there is a translation word related to the translation word outputted from said voice recognition unit in the translation words that correspond to the word but have not been selected by said translation unit, said correction unit corrects the sentence translated by said translation unit, using both the translation words not selected by said translation unit and the translation words outputted from said voice recognition unit.

5. The system according to claim 2, wherein
if there is a relationship between translation words registered in said translation word dictionary file, information indicating the fact is further registered, and
if information indicating that a translation word that corresponds to the word but has not been selected by said translation unit has a relationship with the translation word outputted from said voice recognition unit is registered in said translation word dictionary file, said correction unit corrects the sentence translated by said translation unit, using both the translation word not selected by said translation unit and the translation word outputted from said voice recognition unit.

6. The system according to claim 1, wherein
when a part of speech of the translation word outputted from said voice recognition unit differs from a part of speech of a translation word to be replaced before correction, said correction unit re-translates the whole translated sentence inputted to the translation unit, using the translation word inputted to said voice recognition unit.

7. The system according to claim 6, wherein
if the part of speech of the translation word outputted from said voice recognition unit coincides with the part of speech the translation word to be replaced before correction, said correction unit partially replaces some translation word composing the sentence translated by said translation unit, with the translation word outputted from said voice recognition unit.

8. The system according to claim 1, further comprising
a category determination unit determining a category to which a topic of the original sentence inputted to said translation unit belongs, based on contents corrected by said correction unit,
wherein
when translating a newly inputted original sentence, said translation unit uses with priority a translation word that is frequently used in the category determined by said category determination unit.

9. The system according to claim 8, further comprising
a translation word category information file storage unit storing a translation word category information file in which information indicating a category in which a translation word for a word used in an original sentence is frequently used is registered,
wherein
said category determination unit determines a category in which a translation word used when said correction unit corrects the translated sentence is frequently used, based on information registered in the translation word category information file.

10. The system according to claim 2, further comprising:
a category determination unit determining a category to which a topic of an original sentence inputted to said translation unit belongs,
wherein
information indicating a category in which a translation word registered in the translation word dictionary file is frequently used is further registered in the translation word dictionary file,
said category determination unit determines a category in which a translation word used when said correction unit corrects the translated sentence is frequently used, based on information registered in the translation word category information file, and
when translating a newly inputted original sentence, said translation unit uses with priority a translation word that corresponds to a word used in the inputted original sentence, of a plurality of translation words registered in the translation word dictionary file if information indicating that the translation word is frequently used in a category determined by said category determination unit is registered in the translation word dictionary file.

11. A system for translating an original sentence, comprising:
a translation unit translating an inputted original sentence;
a translation word input unit inputting another translation word when replacing a translation word used in the sentence translated by the translation unit with the translation word; and
a correction unit re-translating the whole original sentence, using the translation word inputted to the translation word input unit if a part of speech of another translation word inputted to the translation word input unit differs from a part of speech of a translation word to be replaced with another translation word.

12. The system according to claim 11, wherein
if the part of speech of the translation word inputted to said translation word input unit coincides with the part of speech of another translation word to be replaced with the translation word, said correction unit partially replaces some translation word composing the sentence translated by said translation unit, with the translation word inputted to the translation word input unit.

13. A system for translating a document, comprising:
a translation unit translating an original sentence composing the document;
a correction unit correcting the sentence translated by the translation unit; and
a category determination unit determining a category to which a topic of the original sentence belongs, based on contents corrected by the correction unit,
wherein
when translating a non-translated original sentence composing the document, the translation unit uses with priority a translation word that is frequently used in the category determined by the category determination unit.

14. The system according to claim 13, further comprising
a translation word category information file storage unit storing a translation word category information file in which information indicating a category in which each word of the original sentence is frequently used, is registered,
wherein
said category determination unit determines a category in which a translation word used when said correction unit has corrected the translated sentence, based on information registered in the translation word category information file.

15. The system according to claim 13, further comprising
a translation word dictionary file storage unit, in which a word used in an original sentence and a translation word for the word are related and registered, storing a translation word dictionary file in which information indicating a category in which the translation word is frequently used, is registered,
wherein
said translation unit translates a non-translated original sentence composing the document using a translation word that is related to the word used in an inputted original sentence, of translation words registered in said translation word dictionary file, and using information indicating that the translation word is frequently used in a category determined by said category determination unit that is registered in said translation word dictionary file.

16. A method for translating an original sentence, comprising:
translating an inputted original sentence by selecting each translation word one by one from a plurality of translation words corresponding to each word composing the original sentence and combining the selected translation words as a result of machine translation;
selecting a translation word matching inputted pronunciation from a plurality of translation words that correspond to the word but have not been selected by the translation unit and outputting the selected translation word as a result of the voice recognition; and
correcting the sentence which is the result of the machine translation, using the translation word which is the result of the voice recognition.

17. A method for supporting translation of an original sentence, comprising:
translating an inputted original sentence;
determining whether a part of speech of another translation word to be inputted to replace a translation word of a translated sentence differs from a part of speech of the translation word to be replaced with another translation; and
re-translating the whole original sentence, using the inputted translation word if the part of speech of another translation word to replace differs from the part of speech of a translation word before correction to be replaced.

18. A method for supporting translation of an original document, comprising:
determining a category to which a topic of the original sentence belongs, based on corrected contents of an original sentence composing a previously translated document; and
translating the original sentence using with priority a translation word frequently used in the category when translating a non-translated sentence composing the document by machine.

19. A computer-readable storage medium on which is recorded a program used to direct a computer to translate an original sentence, said program executed by the computer to perform the processes, comprising:
translating an inputted original sentence by selecting each translation word one by one from a plurality of translation words corresponding to each word composing the original sentence and combining the selected translation words as a result of machine translation;
selecting a translation word matching inputted pronunciation from a plurality of translation words that correspond to the word but have not been selected in the translation process and obtaining the selected translation word as a result of the voice recognition; and
correcting the sentence translated in the translation process, using the translation word obtained in the voice recognition process.

20. A computer-readable storage medium on which is recorded a program used to direct a computer to translate an original sentence, said program executed by the computer to perform the processes, comprising:
translating an inputted original sentence;
obtaining another translation word that replaces a translation word of a sentence translated in the translation process; and
re-translating the whole original sentence, using the translation word obtained in the translation word acquisition process if a part of speech of another translation word obtained in the translation word acquisition process differs from a part of speech of the translation word to be replaced with another translation word in the replacement.

21. A computer-readable storage medium on which is recorded a program used to direct a computer to translate an original sentence, said program executed by the computer to perform the processes, comprising:
determining a category to which a topic of the original sentence belongs, based on corrected contents of an original sentence composing a previously translated document; and
translating a non-translated sentence composing the document using with priority a translation word frequently used in the category.

22. A computer data signal embodied in a carrier wave and representing a program used to direct a computer to translate an original sentence, said program executed by the computer to perform the processes, comprising:
translating an inputted original sentence by selecting each translation word one by one from a plurality of translation words corresponding to each word composing the original sentence and combining the selected translation words as a machine translation;
selecting a translation word matching inputted pronunciation from a plurality of translation words that correspond to the word but have not been selected in the translation process and obtaining the selected translation word as a result of the voice recognition; and
correcting the sentence translated in the translation process, using the translation word obtained in the voice recognition process.

23. A computer data signal embodied in a carrier wave and representing a program used to direct a computer to translate an original sentence, said program executed by the computer to perform the processes, comprising:
translating an inputted original sentence;
obtaining another translation word that replaces a translation word of a sentence translated in the translation process; and
re-translating the whole original sentence, using the translation word obtained in the translation word acquisition process if a part of speech of another translation word obtained in the translation word acquisition process differs from a part of speech of the translation word to be replaced with another translation word in the replacement.

24. A computer data signal embodied in a carrier wave and representing a program used to direct a computer to translate an original sentence, said program executed by the computer to perform the processes, comprising:
determining a category to which a topic of the original sentence belongs, based on corrected contents of an original sentence composing a previously translated document; and
translating a non-translated sentence composing the document using with priority a translation word frequently used in the category.

25. A system for translating an original sentence, comprising:
translation means for translating an inputted original sentence by selecting each translation word one by one from a plurality of translation words corresponding to each word composing the original sentence and combining the selected translation words;
voice recognition means for selecting a translation word matching inputted pronunciation from a plurality of translation words that correspond to the word but have not been selected by the translation means and outputting the selected translation word as a result of the voice recognition; and
correction means for correcting the sentence translated by the translation means using the translation words outputted from the voice recognition means.

26. A system for translating an original sentence, comprising:
translation means for translating an inputted original sentence;
translation word input means for inputting another translation word when replacing a translation word used in the sentence translated by the translation means, with the translation word; and
correction means for re-translating the whole original sentence, using the translation word inputted to the translation word input means if a part of speech of another translation word inputted to the translation word input means differs from a part of speech of a translation word to be replaced with another translation word.

27. A system for translating a document, comprising:
translation means for translating an original sentence composing the document;
correction means for correcting the sentence translated by the translation means; and
category determination means for determining a category to which a topic of the original sentence belongs, based on contents corrected by the correction means,
wherein
when translating a non-translated original sentence composing the document, the translation means uses with priority a translation word that is frequently used in the category determined by the category determination means.
